(19) United States
(12) Patent Application Publication
(10) Pub. No.: US 2026/0254051 A1
(43) Pub. Date: Aug. 27, 2026

(54) ELECTRODE ASSEMBLY, ELECTROCHEMICAL APPARATUS, AND ELECTRONIC APPARATUS

(71) Applicant: Ningde Amperex Technology Limited, Ningde City (CN)

(72) Inventor: Wei Liu, Ningde City (CN)

(73) Assignee: Ningde Amperex Technology Limited, Ningde City (CN)

(21) Appl. No.: 19/552,393

(22) Filed: Feb. 27, 2026

(30) Foreign Application Priority Data
Feb. 27, 2025 (CN) 202510223462.8

(51) Int. Cl. H01M 50/46; H01M 10/0525; H01M 10/0587; H01M 50/431; H01M 50/443; H01M 50/491

(52) U.S. Cl. CPC H01M 50/461; H01M 10/0525; H01M 10/0587; H01M 50/431; H01M 50/443; H01M 50/491

(57) ABSTRACT

An electrode assembly includes two electrode plates and a separator, at least one electrode plate including a main body portion and corner portions, the main body portion includes main body portion protrusions, a height of the main body portion protrusions is H₁ (μm), the corner portion including multiple corner portion protrusions, a height of the corner portion protrusions being H₂ (μm), an orthographic projection of the main body portion protrusions and of the corner portion protrusions along a thickness direction of the electrode plate forming a first pattern and a second pattern, an average radial dimension of the first pattern being R₁ (mm), an average radial dimension of the second pattern being R₂ (mm), satisfying: −0.2665≤H₁/1000R₁−H₂/1000R₂≤0.0131, the separator including a base film and an adhesive layer, a thickness of the adhesive layer being F (μm), satisfying: 4≤H₂/F≤800.

### CROSS REFERENCE TO RELATED APPLICATIONS

The present application claims priority to Chinese Patent Application No. 202510223462.8, filed on Feb. 27, 2025, the disclosure of which is hereby incorporated by reference in its entirety.

### TECHNICAL FIELD

The present application relates to the field of batteries, and in particular, to an electrode assembly, an electrochemical apparatus, and an electronic apparatus.

### BACKGROUND

Currently, the cells of secondary batteries typically adopt a jelly-roll structure. After winding, the cells need to undergo hot pressing to fix the jelly roll, preventing difficulties in subsequent encasement. However, in this case, the wound cell after hot pressing causes difficulties for the electrolyte to enter the interior of the jelly roll, thereby affecting the cycling performance of the cell.

### SUMMARY

Embodiments of the present application provide an electrode assembly, an electrochemical apparatus, and an electronic apparatus. The electrode assembly of the present application increases the interlayer gap between the separator and the electrode plate, making it easier for the electrolyte to enter the interior of the jelly roll, thereby improving the wetting effect of the cell.

In a first aspect, an embodiment of the present application provides an electrode assembly, including: at least two electrode plates and a separator, the separator being disposed between two adjacent electrode plates, the separator including a base film and an inorganic layer, and the inorganic layer being applied to at least one side of the base film. At least one electrode plate includes a main body portion and a corner portion located on the peripheral side of the main body portion, the main body portion including multiple main body portion protrusions, a height of the main body portion protrusions being H₁ (μm), an orthographic projection of the main body portion protrusions along a thickness direction of the electrode plate forming a first pattern (all orthographic projections in the present application refer to the orthographic projection observed from directly above the protrusion perpendicular to the plane where the protrusion is located), an average radial dimension of the first pattern being R₁ (mm), the corner portion including multiple corner portion protrusions, a height of the corner portion protrusions being H₂ (μm), an orthographic projection of the corner portion protrusions along the thickness direction forming a second pattern, an average radial dimension of the second pattern being R₂ (mm), and the main body portion protrusions and the corner portion protrusions satisfying: −0.2665≤H₁/1000R₁−H₂/1000R₂≤0.0131. The separator includes a base film and an adhesive layer, the adhesive layer being disposed on both sides of the base film, a thickness of the adhesive layer being F (μm), and the electrode assembly satisfying: 4≤H₂/F≤800. The average radial dimension in the present application is the longest diameter of the first pattern formed by the orthographic projection of the protrusion along the thickness direction of the electrode plate. In some specific embodiments, if the first pattern/second pattern formed by the orthographic projection is circular, the average radial dimension is the diameter of the circle.

In the present application, by controlling the characteristics of the main body portion protrusions and the corner portion protrusions, when H₁/1000R₁−H₂/1000R₂ satisfies: −0.2665≤H₁/1000R₁−H₂/1000R₂≤0.0131, the electrolyte can infiltrate more uniformly and efficiently into various parts of the cell, greatly improving the wetting effect. At the same time, for the weak region interfaces prone to issues in the cell, the winding stress during the winding process of the electrode assembly and the swelling force due to the swelling of the electrode assembly are effectively buffered, thereby effectively alleviating issues such as hindered ion transmission and poor interface stability in the weak region interfaces, further enhancing the overall performance and stability of the cell, as well as the cycling performance of the battery.

The present application focuses on the ratio relationship between H and R, as H/1000R can characterize the sharpness of the protrusions (bumps). A smaller H/1000R indicates a smoother protrusion, while a larger H/1000R indicates a sharper protrusion. The present application also focuses on the difference in the H/1000R ratio between the main body and corner regions, that is, H₁/1000R₁−H₂/1000R₂, which can characterize the difference between the protrusion structure of the main body portion and the protrusion structure of the corner portion. In the present application, it is found that this difference needs to satisfy the range specified in the present application. When H₁/1000R₁−H₂/1000R₂ is greater than 0.0131, it indicates a larger H₁ value, which leads to excessive gaps between layers in the cell, affecting rapid lithium-ion transmission and thus impacting cycling performance, and causing severe lithium precipitation after cycling. Additionally, a larger H₁ value increases the degree of electrode plate damage, thereby deteriorating the cell processing yield. When H₁/1000R₁−H₂/1000R₂ is less than −0.2665, it indicates a smaller H₁ value and a larger H₂ value, resulting in smaller gaps between layers in the main body region, affecting the flow rate of the electrolyte between layers, and leading to a poor effect of the electrolyte wetting the electrode plate, which in turn affects cycling performance and causes severe lithium precipitation. Therefore, when H₁/1000R₁−H₂/1000R₂ satisfies the range specified in the present application, the difference between the protrusion structure of the main body region and the protrusion structure of the corner region can be maintained within an appropriate range, thereby improving the cycling performance of the battery under high current density, mitigating lithium precipitation on the electrode plate of the battery after high current density cycling, and improving the winding yield.

On this basis, the corner portion protrusions cooperate with the adhesive layer to maintain a stable position of the separator inside the battery, reducing the risk of displacement, wrinkling, or damage, improving the structural regularity inside the battery, and enhancing the stability of the battery during charging and discharging. Additionally, it facilitates better infiltration and diffusion of the electrolyte between the electrode plate and the separator, allowing the electrolyte to fully wet the electrode plate and the separator, improving ion transmission efficiency, and thus enhancing the charging and discharging performance and rate performance of the battery. At the same time, the adhesive layer enables the separator to closely bond with the corner portion protrusions and the main body portion protrusions, forming a stable interface, reducing the resistance at the interface, and lowering the energy loss of the battery during charging and discharging.

In some specific embodiments, the main body portion protrusions satisfy: 0.0005≤H₁/1000R₁≤0.133, and/or the corner portion protrusions satisfy: 0.002≤H₂/1000R₂≤0.267.

In these specific embodiments, the main body portion protrusions satisfying: 0.0005≤H₁/1000R₁≤0.0151, and/or the corner portion protrusions satisfying: 0.002≤H₂/1000R₂≤0.267 can better improve the wetting effect of the electrolyte on the cell, further enhancing the overall performance and stability of the cell.

In some specific embodiments, the main body portion protrusions satisfy: 0.015≤H₁/1000R₁≤0.025, and/or the corner portion protrusions satisfy: 0.0167≤H₂/1000R₂≤0.025. The main body portion protrusions and the corner portion protrusions provide effective support for the separator, enabling the separator to maintain a stable position and shape inside the battery, preventing displacement, deformation, or damage of the separator during the winding of the electrode assembly or during battery use, and ensuring that the separator can normally function to isolate the positive and negative electrodes and prevent short circuits, thereby improving the safety and stability of the battery.

In some specific embodiments, the electrode assembly satisfies at least one of the following: (1) 5≤H₁≤35; (2) 20≤H₂≤80; (3) 0.3≤R₁≤10; or (4) 0.3≤R₂≤10.

In these specific embodiments, when the main body portion protrusions and the corner portion protrusions satisfy one of the above conditions, the main body portion protrusions and the corner portion protrusions can better improve the wetting effect of the electrolyte on the cell, further enhancing the overall performance and stability of the cell.

In some specific embodiments, the separator may further include an inorganic layer, the inorganic layer being disposed between the base film and the adhesive layer, a thickness of the inorganic layer being D (μm), and the electrode assembly satisfying: 3.3≤H₂/D≤160.

In the above specific embodiments, when the electrode assembly satisfies: 3.3≤H₂/D≤160, and the thickness of the inorganic layer and the height H₂ of the corner portion protrusions in the electrode assembly satisfy the above conditions, the inorganic layer has good ion conductivity, providing a smooth transmission channel for lithium ions. A channel conducive to electrolyte flow is formed between the electrode plate and the separator, ensuring that lithium ions in the electrolyte can quickly reach the surface of the inorganic layer. The cooperation of the two enables more efficient transmission of lithium ions between the electrode and the electrolyte, thereby improving the charging and discharging rate of the battery.

At the same time, the inorganic layer and the corner portion protrusion structure work synergistically to distribute the stress generated by the electrode plate over a larger region, avoiding stress concentration, effectively protecting the integrity of the internal structure of the battery, and improving the cycling stability of the battery.

In some specific embodiments, the electrode assembly satisfies: 6.7≤H₂/D≤60.

In the above specific embodiments, when the electrode assembly satisfies: 6.7≤H₂/D≤60, it can further enhance the strength of the electrode assembly, reduce the issue of separator puncture during battery use, and improve the wetting effect of the electrolyte.

In some specific embodiments, the separator may further include an inorganic layer, the inorganic layer being disposed between the base film and the adhesive layer, a thickness of the inorganic layer being D (μm), and the thickness D of the inorganic layer and the height H₂ of the corner portion protrusions having value ranges of: 0.5≤D≤6 and 20≤H₂≤80, respectively.

In the above specific embodiments, the synergistic effect of the inorganic layer and the corner portion protrusions can effectively enhance the strength of the electrode assembly, reduce the issue of separator puncture during battery use, and improve the wetting effect of the electrolyte.

In some specific embodiments, the thickness D of the inorganic layer and the height H₂ of the corner portion protrusions have value ranges of: 1≤D≤3 and 20≤H₂≤60, respectively.

In the above specific embodiments, the synergistic effect of the inorganic layer and the corner portion protrusions can further enhance the strength of the electrode assembly, further reduce the issue of separator puncture during battery use, and improve the wetting effect of the electrolyte.

In some specific embodiments, the separator may further include an inorganic layer, the inorganic layer being disposed between the base film and the adhesive layer, the inorganic layer including inorganic particles, an average particle size of the inorganic particles being E (μm), and the electrode assembly satisfying: 10≤H₂/E≤800.

In the above specific embodiments, when the electrode assembly satisfies: 10≤H₂/E≤800, the synergistic effect of the inorganic particles and the corner portion protrusions can buffer the stress caused by volume changes of the electrode material during battery charging and discharging, reducing the risk of structural damage and pulverization of the electrode material. At the same time, their synergy can optimize the interface contact between the electrode and the electrolyte, making the charge transfer process easier, and reducing the charge transfer resistance.

In some specific embodiments, the electrode assembly satisfies: 20≤H₂/E≤180.

In the above specific embodiments, when the electrode assembly satisfies: 20≤H₂/E≤180, the synergistic effect of the inorganic particles and the corner portion protrusions can further improve the wetting effect of the electrolyte, enhancing the battery yield and battery safety.

In some specific embodiments, the separator may further include an inorganic layer, the inorganic layer being disposed between the base film and the adhesive layer, the inorganic layer including inorganic particles, an average particle size of the inorganic particles being E (μm), and the average particle size E of the inorganic particles and the height H₂ of the corner portion protrusions having value ranges of: 0.1≤E≤2 and 20≤H₂≤80, respectively.

In the above specific embodiments, the synergistic effect of the corner portion protrusions and the inorganic particles increases the surface roughness and irregularity of the electrode assembly, increasing the contact points and contact area between the electrolyte and the electrode plate. At the same time, the inorganic particles can fill the channels formed by the corner portion protrusions, making the channels more stable and regular, and the pores between the inorganic particles can serve as microscopic channels for electrolyte transmission, allowing the electrolyte to penetrate deeper into the material, thereby improving the wetting effect of the electrolyte, and enhancing the battery yield and battery safety.

In some specific embodiments, the inorganic layer includes inorganic particles, the particle size of the inorganic particles being E, and the average particle size E of the inorganic particles and the height H₂ of the corner portion protrusions having value ranges of: 0.3≤E≤1 and 20≤H₂≤60, respectively.

In the above specific embodiments, the synergistic effect of the corner portion protrusions and the inorganic particles, while increasing the surface roughness and irregularity of the electrode assembly, further improves the microstructure of the channels formed by the corner portion protrusions filled with inorganic particles, thereby further improving the wetting effect of the electrolyte, as well as the battery yield and battery safety.

In some specific embodiments, the electrode assembly satisfies at least one of the following: (1) The adhesive layer includes adhesive particles, an average particle size of the adhesive particles being G (μm), where 10≤H₂/G≤800; when 10≤H₂/G≤800, the adhesive particles in the adhesive layer can fill the tiny gaps between the corner portion protrusions, the main body portion protrusions, and the separator, making their adhesion tighter and more secure, ensuring that the separator is not easily displaced or detached inside the battery, and improving the stability of the internal structure of the battery. The synergistic effect of the corner portion protrusions, the main body portion protrusions, and the adhesive particles on the adhesive layer can optimize the transmission path of the electrolyte between the electrode plate and the separator, improving the adsorption and diffusion of the electrolyte, allowing the electrolyte to be more uniformly distributed around the electrode plate and the separator, enhancing ion transmission efficiency, and thus improving the charging and discharging performance and rate performance of the battery. (2) A pore size of the adhesive layer is P (μm), where 0.2≤H₂/P≤160; when 0.2≤H₂/P≤160, the electrolyte can be more uniformly distributed around the electrode plate and the separator, improving ion transmission efficiency, and thus enhancing the charging and discharging performance and rate performance of the battery. (3) A pore size of the adhesive layer is P (μm), where 3≤1000R₂/P≤20000; when 3≤1000R₂/P≤20000, the adhesive layer has better flexibility and deformability, more effectively buffering stress, avoiding damage to the separator due to localized stress concentration, and extending the service life of the separator and the battery.

In some specific embodiments, the electrode assembly satisfies at least one of the following: (1) the thickness of the adhesive layer is F (μm), where 10≤H₂/F≤120; (2) the adhesive layer includes adhesive particles, an average particle size of the adhesive particles being G (μm), where 20≤H₂/G≤600; (3) a pore size of the adhesive layer is P (μm), where 0.4≤H₂/P≤120; or (4) a pore size of the adhesive layer is P (μm), where 20≤1000R₂/P≤6000.

In some specific embodiments, the electrode assembly satisfies at least one of the following: (1) the thickness of the adhesive layer is F (μm), the thickness F of the adhesive layer and the height H₂ of the corner portion protrusions having value ranges of: 0.1≤F≤5 and 20≤H₂≤80, respectively; (2) the adhesive layer includes adhesive particles, an average particle size of the adhesive particles being G (μm), and the average particle size G of the adhesive particles and the height H₂ of the corner portion protrusions having value ranges of: 0.1≤G≤2 and 20≤H₂≤80, respectively; (3) a pore size of the adhesive layer is P (μm), the pore size P of the adhesive layer and the height H₂ of the corner portion protrusions having value ranges of: 0.5≤P≤100 and 20≤H₂≤80, respectively; or (4) a pore size of the adhesive layer is P (μm), the pore size P of the adhesive layer and the average radial dimension R₂ of the second pattern having value ranges of: 0.5≤P≤100 and 0.3≤R₂≤10, respectively.

In the above specific embodiments, when the electrode assembly satisfies one of the above conditions, the combination of the adhesive layer and the protrusion structure can improve the wetting capability of the cell and enhance the liquid retention capability of the battery, reducing battery impedance, thereby improving cycling performance. This further enhances the heat dissipation capability of the cell, achieving improved gas production during high-temperature storage, and improving thermal box performance.

In some specific embodiments, the electrode assembly satisfies at least one of the following: (1) the thickness of the adhesive layer is F (μm), the thickness F of the adhesive layer and the height H₂ of the corner portion protrusions having value ranges of: 0.5≤F≤2 and 20≤H₂≤60, respectively; (2) the adhesive layer includes adhesive particles, an average particle size of the adhesive particles being G (μm), and the average particle size G of the adhesive particles and the height H₂ of the corner portion protrusions having value ranges of: 0.1≤G≤1 and 20≤H₂≤60, respectively; (3) the pore size of the adhesive layer is P (μm), a pore size P of the adhesive layer and the height H₂ of the corner portion protrusions having value ranges of: 0.5≤P≤50 and 20≤H₂≤60, respectively; or (4) a pore size of the adhesive layer is P (μm), the pore size P of the adhesive layer and the average radial dimension R₂ of the second pattern having value ranges of: 0.5≤P≤50 and 1≤R₂≤3, respectively.

In the above specific embodiments, when the electrode assembly satisfies one of the above conditions, the combination of the adhesive layer and the protrusion structure can improve the wetting capability of the cell, and enhance the liquid retention capability of the battery, reducing battery impedance, thereby improving cycling performance. This further enhances the heat dissipation capability of the cell, achieving improved gas production during high-temperature storage, and improving thermal box performance.

In some specific embodiments, at least two electrode plates and the separator are wound around a winding core to form the electrode assembly, the main body portion protrusions being formed by the main body portion protruding toward the winding core, and the corner portion protrusions being formed by the corner portion protruding toward the winding core or formed by the corner portion protruding away from the winding core.

In the above specific embodiments, the corner portion protrusions protruding toward the winding core can occupy a certain space inside the winding core, making the internal structure of the winding core more compact, and accommodating more active substance or other components within the limited battery space, which is beneficial to increasing the energy density of the battery; the corner portion protrusions protruding away from the winding core can form a buffer between the winding core and external structures such as the battery casing, reducing direct collision and friction between the winding core and the casing when the battery is subjected to external impact or vibration, thereby protecting the casing and internal structure of the battery. This reduces the possibility of battery damage due to external factors, improving the safety and reliability of the battery.

In a second aspect, an embodiment of the present application provides an electrochemical apparatus, including: a housing and at least one electrode assembly according to the first aspect, the electrode assembly being disposed inside the housing.

In a third aspect, an embodiment of the present application provides an electronic apparatus, the electronic apparatus being configured to receive electric energy provided by the electrochemical apparatus according to the second aspect.

### DESCRIPTION OF THE DRAWINGS

The features, advantages, and technical effects of exemplary embodiments of the present application will be described below with reference to the accompanying drawings.

FIG. 1 is a schematic structural diagram of an electrode assembly according to an embodiment of the present application;

FIG. 2 is a schematic structural diagram of an electrode plate protrusion according to an embodiment of the present application; and

FIG. 3 is a schematic diagram of spacing arrangement between electrode plate protrusions according to an embodiment of the present application. In the drawings, the drawings are not necessarily drawn to actual scale.

### DETAILED DESCRIPTION

Embodiments of the present application will be described in detail below. Embodiments of the present application should not be construed as limiting the present application.

As used in the present application, the terms “include,” “contain,” and “comprise” are used in their open, non-limiting sense.

Additionally, quantities, ratios, and other numerical values are sometimes presented herein in a range format. It should be understood that such range formats are used for convenience and brevity and should be flexibly interpreted to include not only the numerical values explicitly specified as the limits of the range but also all individual numerical values or sub-ranges encompassed within that range, as if each numerical value and sub-range are explicitly specified.

In the detailed description and claims, a list of items connected by the terms “one or more of,” “one or more,” “at least one of,” or other similar terms may mean any combination of the listed items. For example, if items A and B are listed, the phrase “at least one of A or B” means only A; only B; or A and B. In another example, if items A, B, and C are listed, the phrase “at least one of A, B, or C” means only A; only B; only C; A and B (excluding C); A and C (excluding B); B and C (excluding A); or all of A, B, and C. Item A may include a single element or multiple elements. Item B may include a single element or multiple elements. Item C may include a single element or multiple elements.

The separator and the two electrode plates are wound multiple turns along the length direction of the electrode plates to form the electrode assembly, the length direction of the electrode plate being the direction of winding the electrode plate, and the width direction being perpendicular to the length direction. The electrode assembly is flat, each turn of the electrode plate including two main body portions and two corner portions, and the two main body portions being connected between the two corner portions. The corner portions of adjacent turns of the electrode plates are prone to mutual squeezing, and there is also squeezing between the main body portion and the corner portion of each turn of the electrode plate. Therefore, the corner portion is a high-risk region for squeezing in the electrode assembly. When squeezing occurs at the corner portion, issues such as insufficient electrolyte and poor wetting are likely to occur, leading to deterioration of the electrode plate interface at the corner portion and even cycling failure.

Based on the above situation, embodiments of the present application provide an electrode assembly, an electrochemical apparatus, and an electronic apparatus. The electrode assembly of the present application increases the interlayer gap between the separator and the electrode plate, making it easier for the electrolyte to enter the interior of the jelly roll, thereby improving the wetting effect of the cell. Some embodiments of the present application are described in detail below.

### Electrode Assembly

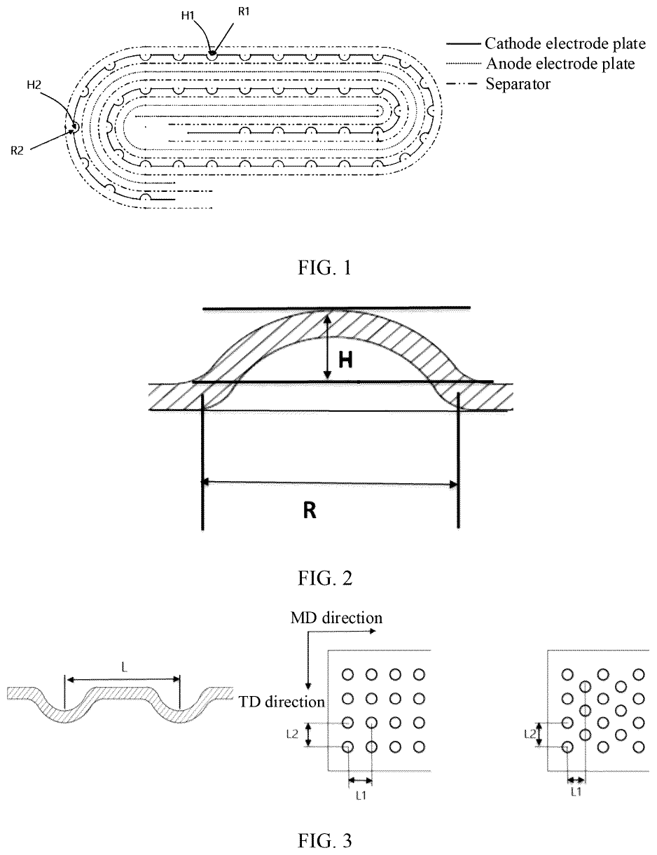

In a first aspect, an embodiment of the present application provides an electrode assembly, as shown in FIG. 1, the electrode assembly of this embodiment of the present application includes two electrode plates with opposite polarities, a separator disposed between the two electrode plates, and the length direction (Machine Direction, MD direction), width direction (Transverse Direction, TD direction), and thickness direction of the two electrode plates with opposite polarities being consistent, and the separator being disposed between the two electrode plates with opposite polarities in the thickness direction of the electrode plates. One of the two electrode plates with opposite polarities is a positive electrode plate, and the other is a negative electrode plate, the separator having insulating properties to separate the positive electrode plate and the negative electrode plate to prevent short circuits.

At least one electrode plate of the two electrode plates is provided with multiple electrode plate protrusions (also referred to as electrode plate bumps), as shown in FIG. 2, the height of the electrode plate protrusions being H (μm), and the average radial dimension of the pattern formed by the orthographic projection of the electrode plate protrusions along the thickness direction of the electrode plate being R (mm). Specifically, the electrode plate includes a main body portion and corner portions disposed at both ends of the main body portion, the main body portion including multiple main body portion protrusions (also referred to as main body portion bumps), a height of the main body portion protrusions being H₁ (μm), an orthographic projection of the main body portion protrusions along the thickness direction of the electrode plate forming a first pattern, an average radial dimension of the first pattern being R₁ (mm), the corner portion including multiple corner portion protrusions (also referred to as corner portion bumps), a height of the corner portion protrusions being H₂ (μm), an orthographic projection of the corner portion protrusions along a thickness direction forming a second pattern, and an average radial dimension of the second pattern being R₂ (mm). In the electrode plate, the main body portion protrusions and the corner portion protrusions satisfy: −0.2665≤H₁/1000R₁−H₂/1000R₂≤0.0131; the separator includes a base film and an adhesive layer, the adhesive layer being disposed on both sides of the base film, a thickness of the adhesive layer being F (μm), and the electrode assembly satisfying: 4≤H₂/F≤800.

For example, H₁/1000R₁−H₂/1000R₂ may be −0.2665, −0.25, −0.22, −0.2, −0.18, −0.15, −0.12, −0.1, −0.08, −0.05, −0.02, 0, 0.01, 0.131, or a range defined by any two of these numerical values.

H₂/F may be 4, 10, 50, 100, 150, 200, 250, 300, 350, 400, 450, 500, 550, 600, 650, 700, 750, 800, or a range defined by any two of these numerical values.

Optionally, −0.25≤H₁/1000R₁−H₂/1000R₂≤0.0131, −0.2≤H₁/1000R₁−H₂/1000R₂≤0.0131, −0.15≤H₁/1000R₁−H₂/1000R₂≤0.0131, −0.1≤H₁/1000R₁−H₂/1000R₂≤0.0131, −0.05≤H₁/1000R₁−H₂/1000R₂≤0.0131, −0.015≤H₁/1000R₁−H₂/1000R₂≤0.0131, −0.2665≤H₁/1000R₁−H₂/1000R₂≤0.0131, −0.2665≤H₁/1000R₁−H₂/1000R₂≤0.01, or −0.2665≤H₁/1000R₁−H₂/1000R₂≤0.0083.

Optionally, 10≤H₂/F≤750, 10≤H₂/F≤700, 10≤H₂/F≤650, 10≤H₂/F≤600, 10≤H₂/F≤550, 10≤H₂/F≤500, 10≤H₂/F≤450, 10≤H₂/F≤400, 10≤H₂/F≤350, 10≤H₂/F≤300, 10≤H₂/F≤250, 10≤H₂/F≤200, 10≤H₂/F≤150, or 10≤H₂/F≤120.

According to the present application, by controlling the characteristics of the main body portion protrusions and the corner portion protrusions, when H₁/1000R₁−H₂/1000R₂ satisfies: −0.2665≤H₁/1000R₁−H₂/1000R₂≤0.0131, the electrolyte can infiltrate more uniformly and efficiently into various parts of the cell, greatly improving the wetting effect. At the same time, for the weak region interfaces prone to issues in the cell, the winding stress during the winding process of the electrode assembly and the swelling force due to the swelling of the electrode assembly are effectively buffered, thereby effectively alleviating issues such as hindered ion transmission and poor interface stability in the weak region interfaces, further enhancing the overall performance and stability of the cell, as well as the cycling performance of the battery.

The present application focuses on the ratio relationship between H and R, as H/1000R can characterize the sharpness of the protrusion structure. A smaller H/1000R indicates a smoother protrusion structure, while a larger H/1000R indicates a sharper protrusion structure. The present application also focuses on the difference in the H/1000R ratio between the main body and corner regions, that is, H₁/1000R₁−H₂/1000R₂, which can characterize the difference between the protrusion structure of the main body region and the protrusion structure of the corner region. In the present application, it is found that this difference needs to satisfy the range specified in the present application. When H₁/1000R₁−H₂/1000R₂ is greater than 0.0131, it indicates a larger H₁ value, which leads to excessive gaps between layers in the cell, affecting rapid lithium-ion transmission and thus impacting cycling performance, and causing severe lithium precipitation after cycling. Additionally, a larger H₁ value increases the degree of electrode plate damage, thereby deteriorating the cell processing yield. When H₁/1000R₁−H₂/1000R₂ is less than −0.2665, it indicates a smaller H1 value and a larger H₂ value, resulting in smaller gaps between layers in the main body region, affecting the flow rate of the electrolyte between layers, and leading to a poor effect of the electrolyte wetting the electrode plate, which in turn affects cycling performance and causes severe lithium precipitation. Therefore, when H₁/1000R₁−H₂/1000R₂ satisfies the range specified in the present application, the difference between the protrusion structure of the main body region and the protrusion structure of the corner region can be maintained within an appropriate range, thereby improving the cycling performance of the battery under high current density, mitigating lithium precipitation on the electrode plate of the battery after high current density cycling, and improving the winding yield.

On this basis, the corner portion protrusions cooperate with the adhesive layer to maintain a stable position of the separator inside the battery, reducing the risk of displacement, wrinkling, or damage, improving the structural regularity inside the battery, and enhancing the stability of the battery during charging and discharging. Additionally, it facilitates better infiltration and diffusion of the electrolyte between the electrode plate and the separator, allowing the electrolyte to fully wet the electrode plate and the separator, improving ion transmission efficiency, and thus enhancing the charging and discharging performance and rate performance of the battery. At the same time, the adhesive layer enables the separator to closely bond with the corner portion protrusions and the main body portion protrusions, forming a stable interface, reducing the resistance at the interface, and lowering the energy loss of the battery during charging and discharging.

The above is merely an exemplary description, and the present application does not limit the orientation of the main body portion protrusions and the corner portion protrusions of each electrode plate, which can be selected according to actual needs.

It should be noted that the height H₁ (μm) of the main body portion protrusions, the diameter R₁ (mm) of the projection of the main body portion protrusions along the thickness direction of the electrode plate, the height H₂ (μm) of the corner portion protrusions, the diameter R₂ (mm) of the projection of the corner portion protrusions along the thickness direction of the electrode plate, and the thickness F (μm) of the adhesive layer can all be measured using methods and instruments known in the art. For example, the electrochemical apparatus can be disassembled to obtain the electrode plate, and the scanning electron microscope (SEM) measurement method can be used. The electrode plate sample is placed in a scanning electron microscope, and high-resolution images of the protrusion structure are obtained through electron beam scanning. In the SEM images, image processing software can be used to draw a measurement line along the height direction of the protrusion structure, and the height of the protrusion structure can be calculated based on the pixel information of the image and the known magnification. Similarly, in the SEM images, the diameter of the protrusion structure can be measured using image processing software to obtain the radius. Alternatively, measurements can be obtained using a VR series shape contour measurement microscope. The electrochemical apparatus can be disassembled to obtain the separator, and the SEM measurement method can be used. The separator is sliced to prepare a flat cross-sectional sample. The sample is placed in an SEM device, appropriate acceleration voltage and scanning parameters are selected, and high-resolution cross-sectional images are obtained. By using the image processing software provided with the SEM, the thickness F of the adhesive layer can be directly measured on the image.

In some embodiments, the main body portion protrusions satisfy: 0.0005≤H₁/1000R₁≤0.133, and/or the corner portion protrusions satisfy: 0.002≤H₂/1000R₂≤0.267.

For example, H₁/1000R₁ may be 0.0005, 0.001, 0.002, 0.005, 0.01, 0.015, 0.0151, 0.02, 0.03, 0.04, 0.05, 0.06, 0.07, 0.08, 0.09, 0.1, 0.11, 0.12, 0.13, 0.133, or a range defined by any two of these numerical values.

For example, H₂/1000R₂ may be 0.002, 0.005, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.267, or a range defined by any two of these numerical values.

Optionally, 0.001≤H₁/1000R₁≤0.133, 0.002≤H₁/1000R₁≤0.133, 0.005≤H₁/1000R₁≤0.133, 0.008≤H₁/1000R₁≤0.133, 0.01≤H₁/1000R₁≤0.133, 0.01≤H₁/1000R₁≤0.1, 0.01≤H₁/1000R₁≤0.08, 0.01≤H₁/1000R₁≤0.06, 0.01≤H₁/1000R₁≤0.04, or 0.01≤H₁/1000R₁≤0.025.

Optionally, 0.005≤H₂/1000R₂≤0.267, 0.008≤H₂/1000R₂≤0.267, 0.01≤H₂/1000R₂≤0.267, 0.012≤H₂/1000R₂≤0.267, 0.015≤H₂/1000R₂≤0.267, 0.0167≤H₂/1000R₂≤0.267, 0.0167≤H₂/1000R₂≤0.2, 0.0167≤H₂/1000R₂≤0.15, 0.0167≤H₂/1000R₂≤0.1, 0.0167≤H₂/1000R₂≤0.08, 0.0167≤H₂/1000R₂≤0.06, 0.0167≤H₂/1000R₂≤0.04, or 0.0167≤H₂/1000R₂≤0.025.

In the above embodiments, when the main body portion protrusions satisfy: 0.0005≤H₁/1000R₁≤0.133, and/or the corner portion protrusions satisfy: 0.002≤H₂/1000R₂≤0.267, the main body portion protrusions and the corner portion protrusions provide effective support for the separator, enabling the separator to maintain a stable position and shape inside the battery, preventing displacement, deformation, or damage of the separator during the winding of the electrode assembly or during battery use, ensuring that the separator can normally function to isolate the positive and negative electrodes and prevent short circuits, thereby improving the safety and stability of the battery.

In some embodiments, the electrode assembly satisfies at least one of the following: (1) 5≤H₁≤40, for example, H₁ may be 20, 30, 35, 40, 50, 60, 70, 80, or a range defined by any two of these numerical values; (2) 20≤H₂≤80, for example, H₂ may be 20, 30, 40, 50, 60, 70, 80, or a range defined by any two of these numerical values; (3) 0.3≤R₁≤10, for example, R₁ may be 0.3, 0.5, 0.8, 1, 2, 3, 4, 5, 6, 7, 8, 9, 10, or a range defined by any two of these numerical values; or (4) 0.3≤R₂≤10, for example, R₂ may be 0.3, 0.5, 0.8, 1, 2, 3, 4, 5, 6, 7, 8, 9, 10, or a range defined by any two of these numerical values.

In the above embodiments, when the electrode assembly satisfies any of the above conditions, the main body portion protrusions and the corner portion protrusions can better improve the wetting effect of the electrolyte on the cell, further enhancing the overall performance and stability of the cell.

In some embodiments, the separator may further include an inorganic layer, the inorganic layer being disposed between the base film and the adhesive layer, a thickness of the inorganic layer being D (μm), and the electrode assembly satisfying: 3.3≤H₂/D≤160. For example, H₂/D may be 3.3, 5, 8, 10, 20, 30, 40, 50, 60, 70, 80, 90, 110, 120, 130, 140, 150, 160, or a range defined by any two of these numerical values.

Optionally, 6.7≤H₂/D≤160, 6.7≤H₂/D≤150, 6.7≤H₂/D≤140, 6.7≤H₂/D≤130, 6.7≤H₂/D≤120, 6.7≤H₂/D≤110, 6.7≤H₂/D≤100, 6.7≤H₂/D≤90, 6.7≤H₂/D≤80, 6.7≤H₂/D≤70, or 6.7≤H₂/D≤60.

In the above embodiments, when the electrode assembly satisfies: 3.3≤H₂/D≤160, and the thickness of the inorganic layer in the electrode assembly and the height H₂of the corner portion protrusions satisfy the above conditions, the inorganic layer has good ion conductivity, providing a smooth transmission channel for lithium ions. A channel conducive to electrolyte flow is formed between the electrode plate and the separator, ensuring that lithium ions in the electrolyte can quickly reach the surface of the inorganic layer. The cooperation of the two enables more efficient transmission of lithium ions between the electrode and the electrolyte, thereby improving the charging and discharging rate of the battery.

At the same time, the inorganic layer and the corner portion protrusion structure work synergistically to distribute the stress generated by the electrode plate over a larger region, avoiding stress concentration, effectively protecting the integrity of the internal structure of the battery, and improving the cycling stability of the battery.

It should be noted that the thickness D (μm) of the inorganic layer can be measured using methods and instruments known in the art. For example, the electrochemical apparatus can be disassembled to obtain the separator, and the scanning electron microscope (SEM) measurement method can be used. The separator is sliced to prepare a flat cross-sectional sample. The sample is placed in an SEM device, appropriate acceleration voltage and scanning parameters are selected, and high-resolution cross-sectional images are obtained. By using the image processing software provided with the SEM, the thickness of the inorganic layer can be directly measured on the image.

In some embodiments, the separator may further include an inorganic layer, the inorganic layer being disposed between the base film and the adhesive layer, a thickness of the inorganic layer being D (μm), and the thickness D of the inorganic layer and the height H₂ of the corner portion protrusions having value ranges of: 0.5≤D≤6 and 20≤H₂≤80, respectively. For example, D may be 0.5, 1, 1.5, 2, 2.5, 3, 3.5, 4, 4.5, 5, 5.5, 6, or a range defined by any two of these numerical values. H₂ may be 20, 25, 30, 35, 40, 45, 50, 55, 60, 65, 70, 75, 80, or a range defined by any two of these numerical values.

Optionally, 1≤D≤6, 1≤D≤5.5, 1≤D≤5, 1≤D≤4.5, 1≤D≤4, 1≤D≤3.5, or 1≤D≤3.

Optionally, 20≤H₂≤78, 20≤H₂≤76, 20≤H₂≤74, 20≤H₂≤72, 20≤H₂70, 20≤H₂≤68, 20≤H₂≤66, 20≤H₂≤64, 20≤H₂≤62, or 20≤H₂≤60.

In the above embodiments, the synergistic effect of the inorganic layer and the corner portion protrusions can effectively enhance the strength of the electrode assembly, reduce the issue of separator puncture during battery use, and improve the wetting effect of the electrolyte.

In some embodiments, the separator may further include an inorganic layer, the inorganic layer being disposed between the base film and the adhesive layer, the inorganic layer including inorganic particles, an average particle size of the inorganic particles being E (μm), and the electrode assembly satisfying: 10≤H₂/E≤800. For example, H₂/E may be 10, 50, 100, 150, 200, 250, 300, 350, 400, 450, 500, 550, 600, 650, 700, 750, 800, or a range defined by any two of these numerical values.

Optionally, 20≤H₂/E≤750, 20≤H₂/E≤700, 20≤H₂/E≤650, 20≤H₂/E≤600, 20≤H₂/E≤550, 20≤H₂/E≤500, 20≤H₂/E≤450, 20≤H₂/E≤400, 20≤H₂/E≤350, 20≤H₂/E≤300, 20≤H₂/E≤250, 20≤H₂/E≤200, or 20≤H₂/E≤180.

In the above embodiments, when the electrode assembly satisfies: 10≤H₂/E≤800, the synergistic effect of the inorganic particles and the corner portion protrusions can buffer the stress caused by volume changes of the electrode material during battery charging and discharging, reducing the risk of structural damage and pulverization of the electrode material. At the same time, their synergy can optimize the interface contact between the electrode and the electrolyte, making the charge transfer process easier, and reducing the charge transfer resistance.

It should be noted that the particle size E (μm) of the inorganic particles can be measured using methods and instruments known in the art. For example, the electrochemical apparatus can be disassembled to obtain the separator, and the scanning electron microscope (SEM) measurement method can be used. The separator sample containing the inorganic layer is processed by drying, fixing, or the like. The sample is then placed in an SEM device, appropriate acceleration voltage and magnification are selected, and high-resolution images of the inorganic particles are obtained. Finally, by using the image processing software provided with the SEM, the particle size of the inorganic particles can be directly measured on the image. The particle size can be characterized by measuring the maximum diameter, minimum diameter, or equivalent diameter of the particles.

In some embodiments, the separator may further include an inorganic layer, the inorganic layer being disposed between the base film and the adhesive layer, the inorganic layer including inorganic particles, an average particle size of the inorganic particles being E (μm), and the average particle size E of the inorganic particles and the height H₂ of the corner portion protrusions having value ranges of: 0.1≤E≤2 and 20≤H₂≤80, respectively. For example, E may be 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, or a range defined by any two of these numerical values. H₂ may be 20, 25, 30, 35, 40, 45, 50, 55, 60, 65, 70, 75, 80, or a range defined by any two of these numerical values.

Optionally, 0.2≤E≤2, 0.3≤E≤2, 0.3≤E≤1.8, 0.3≤E≤1.6, 0.3≤E≤1.4, 0.3≤E≤1.2, or 0.3≤E≤1.

Optionally, 20≤H₂≤78, 20≤H₂≤76, 20≤H₂≤74, 20≤H₂≤72, 20≤H₂70, 20≤H₂≤68, 20≤H₂≤66, 20≤H₂≤64, 20≤H₂≤62, or 20≤H₂≤60.

In the above embodiments, the synergistic effect of the corner portion protrusions and the inorganic particles increases the surface roughness and irregularity of the electrode assembly, increasing the contact points and contact area between the electrolyte and the electrode plate. At the same time, the inorganic particles can fill the channels formed by the corner portion protrusions, making the channels more stable and regular, and the pores between the inorganic particles can serve as microscopic channels for electrolyte transmission, allowing the electrolyte to penetrate deeper into the material, thereby improving the wetting effect of the electrolyte, and enhancing the battery yield and battery safety.

In some embodiments, the electrode assembly satisfies at least one of the following: (1) The adhesive layer includes adhesive particles, an average particle size of the adhesive particles being G (μm), where 10≤H₂/G≤800, for example, H₂/G may be 10, 50, 100, 150, 200, 250, 300, 350, 400, 450, 500, 550, 600, 650, 700, 750, 800, or a range defined by any two of these numerical values; when 10≤H₂/G≤800, the adhesive particles in the adhesive layer can fill the tiny gaps between the corner portion protrusions, the main body portion protrusions, and the separator, making their adhesion tighter and more secure, ensuring that the separator is not easily displaced or detached inside the battery, and improving the stability of the internal structure of the battery. The synergistic effect of the corner portion protrusions, the main body portion protrusions, and the adhesive particles on the adhesive layer can optimize the transmission path of the electrolyte between the electrode plate and the separator, improving the adsorption and diffusion of the electrolyte, allowing the electrolyte to be more uniformly distributed around the electrode plate and the separator, enhancing ion transmission efficiency, and thus improving the charging and discharging performance and rate performance of the battery. (2) A pore size of the adhesive layer is P (μm), where 0.2≤H₂/P≤160, for example, H₂/P may be 0.2, 0.5, 1, 3, 5, 8, 10, 20, 30, 40, 50, 60, 70, 80, 90, 110, 120, 130, 140, 150, 160, or a range defined by any two of these numerical values; when 0.2≤H₂/P≤160, the electrolyte can be more uniformly distributed around the electrode plate and the separator, improving ion transmission efficiency, and thus enhancing the charging and discharging performance and rate performance of the battery. (3) A pore size of the adhesive layer is P (μm), where 3≤1000R₂/P≤20000, for example, 1000R₂/P may be 3, 10, 50, 100, 200, 500, 800, 1000, 2000, 3000, 4000, 5000, 6000, 7000, 8000, 9000, 10000, 11000, 12000, 13000, 14000, 15000, 16000, 17000, 18000, 19000, 20000, or a range defined by any two of these numerical values; when 3≤1000R₂/P≤20000, the adhesive layer has better flexibility and deformability, more effectively buffering stress, avoiding damage to the separator due to localized stress concentration, and extending the service life of the separator and the battery.

Optionally, 20≤H₂/G≤780, 20≤H₂/G≤760, 20≤H₂/G≤740, 20≤H₂/G≤720, 20≤H₂/G≤700, 20≤H₂/G≤680, 20≤H₂/G≤660, 20≤H₂/G≤640, 20≤H₂/G≤620, or 20≤H₂/G≤600.

Optionally, 0.4≤H₂/P≤160, 0.4≤H₂/P≤155, 0.4≤H₂/P≤150, 0.4≤H₂/P≤145, 0.4≤H₂/P≤140, 0.4≤H₂/P≤135, 0.4≤H₂/P≤130, 0.4≤H₂/P≤125, or 0.4≤H₂/P≤120.

Optionally, 10≤1000R₂/P≤20000, 20≤1000R₂/P≤20000, 20≤1000R₂/P≤1 8000, 20≤1000R₂/P≤16000, 20≤1000R₂/P≤14000, 20≤1000R₂/P≤12000, 20≤1000R₂/P≤10000, 20≤1000R₂/P≤8000, or 20≤1000R₂/P≤6000.

It should be noted that the average particle size G (μm) of the adhesive particles and the pore size P (μm) of the adhesive layer can be measured using methods and instruments known in the art. For example, the electrochemical apparatus can be disassembled to obtain the separator, and the thickness of the adhesive layer and the particle size of the adhesive particles can be measured using the same method as for the inorganic layer. The pore size of the adhesive layer can be measured using the bubble point method. The separator sample is completely immersed in a liquid, filling the pores with the liquid. The sample is then placed in a sealed device, gas is slowly introduced, and the gas pressure is gradually increased. The pressure at which the first bubble appears on the sample surface is recorded as the bubble point pressure. Based on known parameters such as the surface tension and contact angle of the liquid, the pore size is calculated using the relevant formula.

In some embodiments, the electrode assembly satisfies at least one of the following: (1) the thickness of the adhesive layer is F (μm), the thickness F of the adhesive layer and the height H₂ of the corner portion protrusions having value ranges of: 0.1≤F≤5 and 20≤H₂≤80, respectively, for example, F may be 0.1, 0.3, 0.5, 0.8, 1, 1.5, 2, 2.5, 3, 3.5, 4, 4.5, 5, or a range defined by any two of these numerical values, H₂ may be 20, 25, 30, 35, 40, 45, 50, 55, 60, 65, 70, 75, 80, or a range defined by any two of these numerical values; (2) the adhesive layer includes adhesive particles, an average particle size of the adhesive particles being G (μm), and the average particle size G of the adhesive particles and the height H₂ of the corner portion protrusions having value ranges of: 0.1≤G≤2 and 20≤H₂≤80, respectively, for example, G may be 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, or a range defined by any two of these numerical values, H₂ may be 20, 25, 30, 35, 40, 45, 50, 55, 60, 65, 70, 75, 80, or a range defined by any two of these numerical values; (3) a pore size of the adhesive layer is P (μm), the pore size P of the adhesive layer and the height H₂ of the corner portion protrusions having value ranges of: 0.5≤P≤100 and 20≤H₂≤80, respectively, for example, P may be 0.5, 1, 5, 10, 20, 30, 40, 50, 60, 70, 80, 90, 100, or a range defined by any two of these numerical values, H₂ may be 20, 25, 30, 35, 40, 45, 50, 55, 60, 65, 70, 75, 80, or a range defined by any two of these numerical values; or (4) a pore size of the adhesive layer is P (μm), the pore size P of the adhesive layer and the average radial dimension R₂ of the second pattern having value ranges of: 0.5≤P≤100 and 0.3≤R₂≤10, respectively, for example, P may be 0.5, 1, 5, 10, 20, 30, 40, 50, 60, 70, 80, 90, 100, or a range defined by any two of these numerical values, and R₂ may be 0.3, 0.5, 0.8, 1, 2, 3, 4, 5, 6, 7, 8, 9, 10, or a range defined by any two of these numerical values.

Optionally, 0.5≤F≤5, 0.5≤F≤4.5, 0.5≤F≤4, 0.5≤F≤3.5,0.5≤F≤3, 0.5≤F≤2.5, or 0.5≤F≤2.

20≤H₂≤78, 20≤H₂≤76, 20≤H₂≤74, 20≤H₂≤72, 20≤H₂≤70, 20≤H₂≤68, 20≤H₂≤66, 20≤H₂≤64, 20≤H₂≤62, or 20≤H₂≤60.

Optionally, 0.1≤G≤1.9, 0.1≤G≤1.8, 0.1≤G≤1.7, 0.1≤G≤1.6,0.1≤G≤1.5, 0.1≤G≤1.4, 0.1≤G≤1.3, 0.1≤G≤1.2, 0.1≤G≤1.1, or 0.1≤G≤1.

20≤H₂≤78, 20≤H₂≤76, 20≤H₂≤74, 20≤H₂≤72, 20≤H₂≤70, 20≤H₂≤68, 20≤H₂≤66, 20≤H₂≤64, 20≤H₂≤62, or 20≤H₂≤60.

Optionally, 0.5≤P≤95, 0.5≤P≤90, 0.5≤P≤85, 0.5≤P≤80, 0.5≤P≤75, 0.5≤P≤70, 0.5≤P≤65, 0.5≤P≤60, 0.5≤P≤55, or 0.5≤P≤50.

20≤H₂≤78, 20≤H₂≤76, 20≤H₂≤74, 20≤H₂≤72, 20≤H₂≤70, 20≤H₂≤68, 20≤H₂≤66, 20≤H₂≤64, 20≤H₂≤62, or 20≤H₂≤60.

Optionally, 0.5≤P≤95, 0.5≤P≤90, 0.5≤P≤85, 0.5≤P≤80, 0.5≤P≤75, 0.5≤P≤70, 0.5≤P≤65, 0.5≤P≤60, 0.5≤P≤55, or 0.5≤P≤50.

0.5≤R₂≤10, 1≤R₂≤10, 1≤R₂≤9, 1≤R₂≤8, 1≤R₂≤7, 1≤R₂≤6, 1≤R₂≤5, 1≤R₂≤4, or 1≤R₂≤3.

In the above embodiments, when the electrode assembly satisfies one of the above conditions, the combination of the adhesive layer and the protrusion structure can improve the wetting capability of the cell, and enhance the liquid retention capability of the battery, reducing battery impedance, thereby improving cycling performance. This further enhances the heat dissipation capability of the cell, achieving improved gas production during high-temperature storage, and improving thermal box performance.

In some embodiments, in some specific embodiments, at least two electrode plates and the separator are wound around a winding core to form the electrode assembly, the main body portion protrusions being formed by the main body portion protruding toward the winding core, and the corner portion protrusions being formed by the corner portion protruding toward the winding core or formed by the corner portion protruding away from the winding core.

In the above embodiments, the corner portion protrusions protruding toward the winding core can occupy a certain space inside the winding core, making the internal structure of the winding core more compact, and accommodating more active substance or other components within the limited battery space, which is beneficial to increasing the energy density of the battery; the corner portion protrusions protruding away from the winding core can form a buffer between the winding core and external structures such as the battery casing, reducing direct collision and friction between the winding core and the casing when the battery is subjected to external impact or vibration, thereby protecting the casing and internal structure of the battery. This reduces the possibility of battery damage due to external factors, improving the safety and reliability of the battery.

In some embodiments, the orthographic projection of the protrusions along the thickness direction of the electrode plate forms a first pattern, the first pattern being a regular circle. In some embodiments, as shown in FIG. 3, the spacing between two adjacent electrode plate protrusions is L, where the chordal spacing between two adjacent electrode plate protrusions is L₁ (mm), the axial spacing is L₂ (mm), and 1≤L₁+L₂≤20, for example, L₁+L₂ may be 1, 2, 3, 4, 5, 6, 7, 8, 9, 10, 11, 12, 13, 14, 15, 16, 17, 18, 19, 20, or a range defined by any two of these numerical values.

It should be noted that the spacing between any corner portion protrusions and main body portion protrusions can be measured using methods and instruments known in the art, for example, direct measurement, measurement using an optical microscope or the like.

In some embodiments, the positive electrode plate may include a positive electrode current collector and a positive electrode active material disposed on at least one surface of the positive electrode current collector.

As an example, the positive electrode current collector has two opposing surfaces in its thickness direction, and the positive electrode active material is disposed on either or both of the opposing surfaces of the positive electrode current collector.

In some embodiments, the negative electrode plate may include a negative electrode current collector.

As an example, the negative electrode plate may include a negative electrode current collector and a negative electrode active material disposed on at least one surface of the negative electrode current collector.

As an example, the negative electrode current collector has two opposing surfaces in its thickness direction, and the negative electrode active material is disposed on either or both of the opposing surfaces of the negative electrode current collector.

In some embodiments, the present application does not specifically limit the type of separator, and any well-known porous structure separator with good chemical stability and mechanical stability can be used.

As an example, the main material of the separator may be selected from at least one of glass fiber, non-woven fabric, polyethylene, polypropylene, polyvinylidene fluoride, and ceramics. The separator may be a single-layer film or a multi-layer composite film, without particular limitation. When the separator is a multi-layer composite film, the materials of various layers may be the same or different, without particular limitation. The separator may be a separate component located between the positive and negative electrodes, or it may be attached to the surface of the positive and negative electrodes. The surface of the separator may also be coated with an inorganic particle coating, an organic particle coating, or an organic/inorganic composite coating.

As an example, multiple positive electrode plates and multiple negative electrode plates may be provided, and the multiple positive electrode plates and multiple negative electrode plates are alternately stacked.

As an example, multiple positive electrode plates may be provided, and the negative electrode plate is folded to form multiple stacked folded segments, with a positive electrode plate clamped between adjacent folded segments.

As an example, both the positive electrode plate and the negative electrode plate are folded to form multiple stacked folded segments.

As an example, multiple separators may be provided, respectively disposed between any adjacent positive electrode plates or negative electrode plates.

In some embodiments, the electrode assembly is provided with tabs, and the tabs can conduct current out of the electrode assembly. The tabs include a positive tab and a negative tab.

According to a second aspect, an electrochemical apparatus is provided, including: a housing and at least one electrode assembly according to the first aspect, the electrode assembly being disposed inside the housing.

In some embodiments of the present application, the electrochemical apparatus may be a secondary battery cell, a secondary battery cell referring to a battery cell that can be recharged to activate the active material for continued use after discharge.

The secondary battery cell may be a lithium-ion battery cell, a sodium-ion battery cell, a sodium-lithium-ion battery cell, a lithium metal battery cell, a sodium metal battery cell, a lithium-sulfur battery cell, a magnesium-ion battery cell, a nickel-hydrogen battery cell, a nickel-cadmium battery cell, a lead-acid battery cell, or the like, and these embodiments of the present application are not limited thereto.

The secondary battery cell generally includes an electrode assembly. The electrode assembly includes a positive electrode and a negative electrode. During the charging and discharging process of the battery cell, active ions (for example, lithium ions) are intercalated and deintercalated back and forth between the positive electrode and the negative electrode.

In some embodiments, the secondary battery cell may further include an electrolyte, and the electrolyte serves to conduct ions between the positive and negative electrodes. The present application does not specifically limit the type of electrolyte, which can be selected according to requirements. The electrolyte may be liquid, gel, or solid.

The liquid electrolyte includes an electrolytic salt and a solvent.

In some embodiments, the electrolytic salt may be selected from at least one of lithium hexafluorophosphate, lithium tetrafluoroborate, lithium perchlorate, lithium hexafluoroarsenate, lithium bis(fluorosulfonyl)imide, lithium lithium bis(trifluoromethanesulfonyl)imide, lithium trifluoromethanesulfonate, difluorophosphate, lithium difluoro(oxalato) borate, lithium bis(oxalato)borate, lithium difluoro(bisoxalato)phosphate, and lithium tetrafluoro(oxalato)phosphate.

In some embodiments, the solvent may be selected from at least one of ethylene carbonate, propylene carbonate, ethyl methyl carbonate, diethyl carbonate, dimethyl carbonate, dipropyl carbonate, methyl propyl carbonate, ethyl propyl carbonate, butylene carbonate, fluoroethylene carbonate, methyl formate, methyl acetate, ethyl acetate, propyl acetate, methyl propionate, ethyl propionate, propyl propionate, methyl butyrate, ethyl butyrate, 1,4-butyrolactone, sulfolane, dimethyl sulfone, methyl ethyl sulfone, and diethyl sulfone. The solvent may also be selected from ether solvents. The ether solvents may include one or more of ethylene glycol dimethyl ether, ethylene glycol diethyl ether, diethylene glycol dimethyl ether, triethylene glycol dimethyl ether, tetraethylene glycol dimethyl ether, 1,3-dioxolane, tetrahydrofuran, methyltetrahydrofuran, diphenyl ether, and crown ether.

In some embodiments, the electrolyte may optionally include additives. For example, the additives may include negative electrode film-forming additives, positive electrode film-forming additives, and additives that can improve certain performance aspects of the battery cell, such as additives that improve overcharge/fast-charging performance of the battery cell, high-temperature performance of the battery cell, or low-temperature performance of the battery cell.

In some embodiments, the secondary battery cell may include a casing. The casing may be a steel casing, aluminum casing, plastic casing (for example, polypropylene), composite metal casing (for example, copper-aluminum composite casing), aluminum-plastic film, or the like.

In some embodiments, the casing may be a sealed structure or a non-sealed structure.

As an example, when the casing is a non-sealed structure, the casing serves to protect the electrode assembly, and a sealing bag may also be included between the casing and the electrode assembly, the sealing bag being used to encapsulate the electrode assembly and the electrolyte. Specifically, the sealing bag may be a bag-shaped insulating member or an aluminum-plastic film. When the casing is a sealed structure, it is used to encapsulate components such as the electrode assembly and the electrolyte.

In some embodiments, the casing includes an end cap and a housing, the housing having an opening, and the end cap covering the opening. The housing may have one or more openings. One or more end caps may also be provided.

In some embodiments, the casing is provided with at least one electrode terminal, the electrode terminal being electrically connected to the tab. The electrode terminal may be directly connected to the tab or indirectly connected to the tab through a current collector member. The electrode terminal may be disposed on the end cap or on the housing.

Some embodiments of the present application also provide an electronic apparatus including the above electrochemical apparatus. The electronic apparatus of some embodiments of the present application is not particularly limited and may be any electronic apparatus known in the prior art. In some embodiments, the electronic apparatus may include, but is not limited to, notebook computers, pen-input computers, mobile computers, e-book readers, portable phones, portable fax machines, portable copiers, portable printers, head-mounted stereo earphones, video recorders, LCD televisions, handheld cleaners, portable CD players, mini-disc players, transceivers, electronic notebooks, calculators, memory cards, portable recorders, radios, backup power supplies, motors, automobiles, motorcycles, electric bicycles, bicycles, lighting fixtures, toys, gaming consoles, clocks, power tools, flashlights, cameras, large household batteries, and lithium-ion capacitors.

### EXAMPLES

The following examples describe the content disclosed in the present application in more detail. These examples are provided solely for illustrative purposes, as various modifications and changes within the scope of the disclosure of the present application will be apparent to those skilled in the art. Unless otherwise stated, all parts, percentages, and ratios reported in the following examples are based on weight, all reagents used in the examples are commercially available or synthesized by conventional methods and can be used directly without further processing, and all instruments used in the examples are commercially available.

The following methods were used in the examples and comparative examples of the present application to prepare lithium-ion batteries and test the performance of the lithium-ion batteries:

### Example 1-1

### 1. Preparation Method of Lithium-Ion Battery

### (1) Preparation of Positive Electrode Plate

Positive electrode active material lithium cobalt oxide (LiCoO₂), conductive agent carbon black, and binder polyvinylidene fluoride PVDF were dissolved in N-methylpyrrolidone NMP solution at a weight ratio of 97.9:0.9:1.2 to form a positive electrode slurry. A 9 μm aluminum foil was used as a positive electrode current collector, and the positive electrode slurry was applied onto the positive electrode current collector. After drying, cold pressing, and cutting, a positive electrode plate was obtained. A compacted density of the positive electrode active material layer of the positive electrode plate was 4.2 g/cm³.

### (2) Preparation of Negative Electrode Plate

Negative electrode active material artificial graphite, binder styrene-butadiene rubber SBR, and thickener sodium carboxymethyl cellulose CMC were dissolved in deionized water at a weight ratio of 97.4:1.4:1.2 to form a negative electrode slurry. A 10 μm thick copper foil was used as a negative electrode current collector, and the negative electrode slurry was applied onto the negative electrode current collector. After drying, cold pressing, and cutting, a negative electrode plate was obtained. A compacted density of the negative electrode active material layer of the negative electrode plate was 1.8 g/cm³.

In the following examples and comparative examples, the negative electrode plate has main body portion protrusions and corner portion protrusions.

### (3) Preparation of Separator

A separator substrate was a 5 μm thick polyethylene PE film, coated on one side with a 2 μm thick alumina ceramic layer. Finally, both sides of the separator substrate with a single ceramic layer were coated with 2.5 mg/1540.25 mm² of the binder polyvinylidene fluoride PVDF and dried to form adhesive layers. A porosity of the adhesive layer of the separator was 39%.

### (4) Preparation of Electrolyte

In an environment with a water content of less than 10 ppm, ethylene carbonate (EC), propylene carbonate (PC), diethyl carbonate (DEC), ethyl propionate (EP), and propyl propionate (PP) were mixed well at a mass ratio of 1:1:1:1:1. The electrolytic salt LiPF₆ was then dissolved in the above non-aqueous solvent and mixed well to form an electrolyte, where based on the mass of the electrolyte, a mass percentage of LiPF₆ was 12.5%.

(5) Assembly of Lithium-Ion Battery

The positive electrode plate with a positive tab, the separator, and the negative electrode plate with a negative tab were sequentially stacked in order, with the separator positioned between the positive electrode plate and the negative electrode plate to provide isolation, and then wound to obtain the electrode assembly. The electrode assembly was placed in an aluminum-plastic film outer packaging, dehydrated at 80°° C., injected with the above electrolyte, and encapsulated. After formation, degassing, and trimming processes, the lithium-ion battery was obtained. The following describes the test methods for various parameters in the examples of the present application.

### 2. Performance Testing of Lithium-Ion Battery

### (1) Cycling Test and Lithium Precipitation Test

Room temperature cycling test: In a 25° C. environment, the electrode assembly was charged at a constant current of 3C to the full charge voltage (designed maximum voltage of the battery: 4.5 V), then charged at constant voltage of the maximum voltage until the current reached 0.02C, and then discharged at a constant current of 0.7C until the final voltage was 3.0 V. The discharge capacity of the first cycle was recorded. Subsequently, the above conditions and steps were repeated for 1000 charge-discharge cycles, and the discharge capacity of the lithium-ion battery after 1000 charge-discharge cycles was recorded.

After testing at 25° C. and 1000 charge-discharge cycles, when the battery was in a fully charged state (designed maximum voltage of the battery: 4.5 V), it was disassembled to observe whether lithium precipitation occurred at the negative electrode interface/tab/protective adhesive. The criterion for determining the presence of lithium precipitation was: a lithium precipitation area was greater than 1 square millimeter, occurring in more than 30% of the number of the layers.

### (3) Winding Yield Test

The separator was placed between two electrode plates (positive electrode plate and negative electrode plate) of opposite polarities on an integrated winding machine to form the electrode assembly by winding. X-ray equipment was used to measure the distance M (M>0.1 mm indicated qualification) by which the edge of the negative electrode plate of the electrode assembly exceeds the edge of the positive electrode plate in the width direction of the positive electrode plate. Continuous sampling was performed, with the total number of samples T (total number: 100) and the number of qualified products N recorded.

$$Winding yield = N / T \times 100 \% .$$

### (4) Test Method for Average Radial Dimension R and Height H

The electrode plate was measured using the scanning electron microscope (SEM) measurement method. The electrode plate sample was placed in a scanning electron microscope, and high-resolution images of the protrusion structure were obtained through electron beam scanning. In the SEM images, image processing software was used to draw a measurement line along the height direction of the protrusion structure, and the height of the protrusion structure was calculated based on the pixel information of the image and the known magnification. Similarly, in the SEM images, the diameter of the protrusion structure was measured using image processing software, and the average radial dimension was obtained by averaging three values from three positions. Alternatively, measurements could be obtained using a VR series shape contour measurement microscope.

### Example 1-2 to Example 1-12, Comparative Example 1-1 and Comparative Example 1-2

The differences between Example 1-2 to Example 1-12, Comparative Example 1-1 and Comparative Example 1-2, and Example 1-1 lied in the values of the height H₁ of the main body portion protrusions, the diameter R₁ of the main body portion protrusions, H₁/1000R₁, the height H₂ of the corner portion protrusions, the diameter R₂ of the corner portion protrusions, H₂/1000R₂, and H₁/1000R₁−H₂/1000R₂. Details are shown in Table 1.

TABLE 1

| | | | | | | | | Retention rate | | |
|---|---|---|---|---|---|---|---|---|---|---|
| | | | | | | | | after 25° C. | | |
| | | | | | | | H₁/ | 1000 charge- | | |
| | | | | | | | 1000R₁ − | discharge | Lithium | Winding |
| | H₁ | R₁ | H₁/ | H₂ | R₂ | H₂/ | H₂/ | cycles | precipitation | yield |
| | (μm) | (μm) | 1000R₁ | (μm) | (μm) | 1000R₂ | 1000R₂ | (%) | status | (%) |
| Example 1-1 | 5 | 10 | 0.0005 | 80 | 0.3 | 0.267 | −0.2665 | 89.6 | None | 97.8 |
| Example 1-2 | 5 | 1 | 0.005 | 20 | 0.8 | 0.025 | −0.02 | 90.4 | None | 97.9 |
| Example 1-3 | 10 | 1 | 0.01 | 20 | 0.8 | 0.025 | −0.015 | 91 | None | 98.6 |
| Example 1-4 | 10 | 0.67 | 0.015 | 20 | 0.8 | 0.025 | −0.01 | 91.6 | None | 98.8 |
| Example 1-5 | 30 | 1 | 0.03 | 20 | 0.8 | 0.025 | 0.005 | 91.8 | None | 99 |
| Example 1-6 | 25 | 1 | 0.025 | 33 | 2 | 0.0167 | 0.0083 | 91.3 | None | 98.6 |
| Example 1-7 | 25 | 1 | 0.025 | 27 | 1.8 | 0.015 | 0.01 | 88.7 | None | 98.1 |
| Example 1-8 | 15.1 | 1 | 0.0151 | 20 | 10 | 0.002 | 0.0131 | 88.7 | None | 98 |
| Example 1-9 | 150 | 10 | 0.015 | 28 | 0.8 | 0.035 | −0.02 | 81 | Present | 98 |
| Example 1-10 | 35 | 1 | 0.035 | 45 | 1.8 | 0.025 | 0.01 | 80 | Present | 95.2 |
| Example 1-11 | 45 | 0.3 | 0.15 | 20 | 0.8 | 0.025 | 0.02 | 79 | Present | 92.2 |
| Example 1-12 | 2 | 10 | 0.0002 | 20 | 0.8 | 0.025 | −0.0248 | 80.6 | Present | 93.6 |
| Comparative | 20 | 1 | 0.02 | 320 | 1 | 0.32 | −0.3 | 66.8 | Present | 86.6 |
| Example 1-1 | | | | | | | | | | |
| Comparative | 170 | 0.5 | 0.34 | 320 | 1 | 0.32 | 0.02 | 69.2 | Present | 88 |
| Example 1-2 | | | | | | | | | | |

According to Table 1, compared to the comparative examples, the examples show improvements in the retention rate after 25° C. 1000 charge-discharge cycles, lithium precipitation status, and winding yield. When the main body portion protrusions and corner portion protrusions of the electrode assembly satisfy: −0.2665≤H₁/1000R₁−H₂/1000R₂≤0.0131, the lithium-ion battery exhibits better cycling performance, and the electrode assembly has a better winding yield.

According to Examples 1-3 to 1-6, when −0.015≤H₁/1000R₁−H₂/1000R₂≤0.0083, the lithium-ion battery exhibits even better cycling performance, and the electrode assembly has an even better winding yield.

### Example 2-1 to Example 2-9

The differences between Example 2-1 to Example 2-9 and Example 1-1 lied in the specific settings of the thickness D of the inorganic layer, the height H₂ of the corner portion protrusions, and H2/D in Example 2-1 to Example 2-9, as detailed in Table 2.

TABLE 2

| | | | | Retention rate | | |
|---|---|---|---|---|---|---|
| | | | | after 25° C. | Lithium | Wind- |
| | | | | 1000 charge- | precip- | ing |
| | H₂ | D | H₂/ | discharge cycles | itation | yield |
| | (μm) | (μm) | D | (%) | status | (%) |
| Example 2-1 | 20 | 6 | 3.3 | 89 | None | 98.1 |
| Example 2-2 | 20 | 4 | 5.0 | 89 | None | 98.2 |
| Example 2-3 | 20 | 3 | 6.7 | 89.9 | None | 99 |
| Example 2-4 | 36 | 1.2 | 30 | 90.6 | None | 99.3 |
| Example 2-5 | 60 | 1 | 60 | 90.4 | None | 99 |
| Example 2-6 | 50 | 0.5 | 100 | 89.2 | None | 98.4 |
| Example 2-7 | 80 | 0.5 | 160 | 89 | None | 98.2 |
| Example 2-8 | 20 | 10 | 2 | 80.2 | Present | 95 |
| Example 2-9 | 100 | 0.5 | 200 | 78.1 | Present | 94 |

According to Table 2, when the height H₂ of the corner portion protrusions and the thickness D of the inorganic layer work synergistically, the lithium-ion battery exhibits better cycling performance, and the electrode assembly has a better winding yield.

According to Example 2-1 to Example 2-9, when 3.3≤H₂/D≤160, the lithium-ion battery exhibits better cycling performance, and the electrode assembly has a better winding yield.

Based on this, according to Example 2-3 to Example 2-5, when 6.7≤H₂/D≤60, the lithium-ion battery exhibits even better cycling performance, and the electrode assembly has an even better winding yield.

### Example 3-1 to Example 3-10

The differences between Example 3-1 to Example 3-10 and Example 1-1lied in the specific settings of the average particle size E of the inorganic particles in the inorganic layer, the height H₂ of the corner portion protrusions, and H₂/E in Example 3-1 to Example 3-10, as detailed in Table 3.

TABLE 3

| | | | | Retention rate | | |
|---|---|---|---|---|---|---|
| | | | | after 25° C. | Lithium | Wind- |
| | | | | 1000 charge- | precip- | ing |
| | H₂ | E | H₂/ | discharge cycles | itation | yield |
| | (μm) | (μm) | E | (%) | status | (%) |
| Example 3-1 | 20 | 2 | 10 | 88.5 | None | 98.6 |
| Example 3-2 | 20 | 1.33 | 15 | 88.2 | None | 98.4 |
| Example 3-3 | 20 | 1 | 20 | 89.9 | None | 99.4 |
| Example 3-4 | 20 | 0.2 | 100 | 90.2 | None | 99.1 |
| Example 3-5 | 20 | 0.11 | 180 | 90.4 | None | 99 |
| Example 3-6 | 30 | 0.1 | 300 | 89.2 | None | 98.4 |
| Example 3-7 | 50 | 0.1 | 500 | 89 | None | 98.2 |
| Example 3-8 | 80 | 0.1 | 800 | 88.7 | None | 98.4 |
| Example 3-9 | 16 | 2 | 8 | 78.5 | Present | 95.4 |
| Example | 100 | 0.1 | 1000 | 75.9 | Present | 93.4 |
| 3-10 | | | | | | |

According to Table 3, when the height H₂ of the corner portion protrusions and the average particle size E of the inorganic particles in the inorganic layer work synergistically, the lithium-ion battery exhibits better cycling performance, and the electrode assembly has a better winding yield.

According to Example 3-1 to Example 3-10, when 10≤H₂/E≤800, the lithium-ion battery exhibits better cycling performance, and the electrode assembly has a better winding yield.

Based on this, according to Example 3-3 to Example 3-5, when 20≤H₂/E≤180, the lithium-ion battery exhibits even better cycling performance, and the electrode assembly has an even better winding yield.

Example 4-1 to Example 4-9

The differences between Example 4-1 to Example 4-9 and Example 1-1 lied in the thickness F of the adhesive layer, the height H₂ of the corner portion protrusions, and H₂/F in Example 4-1 to Example 4-9, as detailed in Table 4.

TABLE 4

| | | | | Retention rate | | |
|---|---|---|---|---|---|---|
| | | | | after 25° C. | Lithium | Wind- |
| | | | | 1000 charge- | precip- | ing |
| | H₂ | F | H₂/ | discharge cycles | itation | yield |
| | (μm) | (μm) | F | (%) | status | (%) |
| Example 1-1 | 80 | 1.6 | 50 | 89.6 | None | 98.3 |
| Example 4-1 | 20 | 5 | 4 | 88.8 | None | 99.2 |
| Example 4-2 | 32 | 4 | 8 | 89 | None | 99.2 |
| Example 4-3 | 20 | 2 | 10 | 90 | None | 99.4 |
| Example 4-4 | 20 | 0.4 | 50 | 90 | None | 99.2 |
| Example 4-5 | 60 | 0.5 | 120 | 90.7 | None | 99.2 |
| Example 4-6 | 40 | 0.2 | 200 | 89.2 | None | 98.4 |
| Example 4-7 | 80 | 0.1 | 800 | 89 | None | 98.2 |
| Example 4-8 | 15 | 5 | 3 | 80.5 | Present | 96.4 |
| Example 4-9 | 200 | 0.2 | 1000 | 78.8 | Present | 90.2 |

According to Table 4, when the height H₂ of the corner portion protrusions and the thickness F of the adhesive layer work synergistically, the lithium-ion battery exhibits better cycling performance, and the electrode assembly has a better winding yield.

According to Example 1-1 and Example 4-1 to Example 4-9, when 4≤H₂/F ≤800, the lithium-ion battery exhibits better cycling performance, and the electrode assembly has a better winding yield.

Based on this, according to Example 4-3 to Example 4-5, when 10≤H₂/F≤120, the lithium-ion battery exhibits even better cycling performance, and the electrode assembly has an even better winding yield.

### Example 5-1 to Example 5-9

The differences between Example 5-1 to Example 5-9 and Example 1-1 lied in the average particle size G of the adhesive particles in the adhesive layer, the height H₂ of the corner portion protrusions, and H₂/G in Example 5-1 to Example 5-9, as detailed in Table 5.

TABLE 5

| | | | | Retention rate | | |
|---|---|---|---|---|---|---|
| | | | | after 25° C. | Lithium | Wind- |
| | | | | 1000 charge- | precip- | ing |
| | H₂ | G | H₂/ | discharge cycles | itation | yield |
| | (μm) | (μm) | G | (%) | status | (%) |
| Example 1-1 | 80 | 2 | 40 | 89.6 | None | 98.3 |
| Example 5-1 | 20 | 2 | 10 | 88 | None | 98 |
| Example 5-2 | 20 | 1.33 | 15 | 88.4 | None | 97.8 |
| Example 5-3 | 20 | 1 | 20 | 90.4 | None | 98.2 |
| Example 5-4 | 30 | 0.1 | 300 | 90.1 | None | 99.1 |
| Example 5-5 | 60 | 0.1 | 600 | 90.4 | None | 99 |
| Example 5-6 | 70 | 0.1 | 700 | 89.2 | None | 98.2 |
| Example 5-7 | 80 | 0.1 | 800 | 89 | None | 98.2 |
| Example 5-8 | 16 | 2 | 8 | 83.2 | Present | 95.8 |
| Example 5-9 | 100 | 0.1 | 1000 | 81 | Present | 92 |

According to Table 5, when the height H₂ of the corner portion protrusions and the average particle size G of the adhesive particles in the adhesive layer work synergistically, the lithium-ion battery exhibits better cycling performance, and the electrode assembly has a better winding yield.

According to Example 1-1 and Example 5-1 to Example 5-9, when 10≤H2/G≤800, the lithium-ion battery exhibits better cycling performance, and the electrode assembly has a better winding yield.

Based on this, according to Example 5-3 to Example 5-5, when 20≤H₂/G≤600, the lithium-ion battery exhibits even better cycling performance, and the electrode assembly has an even better winding yield.

### Example 6-1 to Example 6-9

The differences between Example 6-1 to Example 6-9 and Example 1-1 lied in the pore size P of the adhesive layer, the height H₂ of the corner portion protrusions, the diameter R₂ of the corner portion protrusions, H₂/P, and 1000R₂/P in Example 6-1to Example 6-9, as detailed in Table 6.

TABLE 6

| | | | | | | Retention rate | | |
|---|---|---|---|---|---|---|---|---|
| | | | | | | after 25° C. | | |
| | | | | | | 1000 charge- | Lithium | Winding |
| | H₂ | R₂ | P | | 1000R₂/ | discharge cycles | precipitation | yield |
| | (μm) | (μm) | (μm) | H₂/P | P | (%) | status | (%) |
| Example 1-1 | 80 | 0.3 | 100 | 0.8 | 3 | 89.6 | None | 98.3 |
| Example 6-1 | 20 | 0.3 | 100 | 0.2 | 3 | 88.6 | None | 98 |
| Example 6-2 | 50 | 4 | 200 | 0.4 | 20 | 90.4 | None | 98.6 |
| Example 6-3 | 50 | 1 | 1 | 50 | 1000 | 91 | None | 98.8 |
| Example 6-4 | 60 | 3 | 0.5 | 120 | 6000 | 90.6 | None | 98.5 |
| Example 6-5 | 80 | 10 | 0.5 | 160 | 20000 | 89.2 | None | 98 |
| Example 6-6 | 10 | 0.3 | 100 | 0.1 | 3 | 79.2 | Present | 95.2 |
| Example 6-7 | 90 | 3 | 0.5 | 180 | 6000 | 78 | Present | 90.8 |
| Example 6-8 | 20 | 0.2 | 100 | 0.2 | 2 | 76.5 | Present | 94.7 |
| Example 6-9 | 60 | 12.5 | 0.5 | 120 | 25000 | 75.6 | Present | 90.2 |

According to Table 6, when the height H₂ of the corner portion protrusions, the diameter R₂, and the pore size P of the adhesive layer work synergistically, the lithium-ion battery exhibits better cycling performance, and the electrode assembly has a better winding yield.

According to Example 1-1 and Example 6-1 to Example 6-9, when 0.2≤H₂/P≤160 and 3≤1000R₂/P≤20000, the lithium-ion battery exhibits better cycling performance, and the electrode assembly has a better winding yield.

Based on this, according to Example 6-2 to Example 6-4, when 0.4≤H₂/P≤120 and 20≤1000R₂/P≤6000, the lithium-ion battery exhibits even better cycling performance, and the electrode assembly has an even better winding yield.

Although the present application has been described with reference to preferred examples, various improvements can be made, and components therein can be replaced with equivalents without departing from the scope of the present application. In particular, as long as there is no structural conflict, the technical features mentioned in the various examples can be combined in any manner. The present application is not limited to the specific examples disclosed herein but includes all technical solutions falling within the scope of the claims.

What is claimed is:

1. An electrode assembly, comprising at least two electrode plates and a separator, the separator being disposed between two adjacent electrode plates;
at least one of the electrode plates comprises a main body portion and corner portions located on both sides of the main body portion, the main body portion comprising multiple main body portion protrusions, a height of each main body portion protrusion is H₁ (μm), an orthographic projection of the each main body portion protrusion along a thickness direction of the electrode plate forming a first pattern, an average radial dimension of the first pattern of the main body protrusions is R₁ (mm), the corner portion comprising multiple corner portion protrusions, a height of each corner portion protrusions is H₂ (μm), an orthographic projection of the each corner portion protrusion along the thickness direction forming a second pattern, and an average radial dimension of the second pattern of the corner portion protrusions is R₂
$$( mm ) , wherein - 0.2 665 \leq {H}_{1} / 1000 {R}_{1} - {H}_{2} / 1000 {R}_{2} \leq 0.0131 ;$$
and
the separator comprises a base film and an adhesive layer, the adhesive layer being disposed on both sides of the base film, a thickness of the adhesive layer being F (μm), and the electrode assembly satisfying: 4≤H₂/F≤800.

2. The electrode assembly according to claim 1, wherein the electrode assembly is a wound electrode assembly, wherein each turn of the electrode plate in the wound electrode assembly includes two main body portions and two corner portions, and the two main body portions are connected between the two corner portions.

3. The electrode assembly according to claim 1, wherein 0.0005≤H₁/1000R₁≤0.0151 is satisfied, and/or 0.002≤H₂/1000R₂≤0.267.

4. The electrode assembly according to claim 1, wherein 0.015≤H₁/1000R₁≤0.025 is satisfied, and/or 0.0167≤H₂/1000R₂≤0.025.

5. The electrode assembly according to claim 1, wherein the electrode assembly satisfies at least one of the following:
$$5 \leq {H}_{1} \leq 35 ; \qquad ( 1 )$$
$$20 \leq {H}_{2} \leq 80 ; \qquad ( 2 )$$
$$0.3 \leq {R}_{1} \leq 10 ; or \qquad ( 3 )$$
$$0.3 \leq {R}_{2} \leq 10 . \qquad ( 4 )$$

6. The electrode assembly according to claim 1, wherein the separator further comprises an inorganic layer, the inorganic layer being disposed between the base film and the adhesive layer, a thickness of the inorganic layer being D (μm), and the electrode assembly satisfying: 3.3≤H₂/D≤160.

7. The electrode assembly according to claim 6, wherein 6.7≤H₂/D≤60.

8. The electrode assembly according to claim 1, wherein the separator further comprises an inorganic layer, the inorganic layer being disposed between the base film and the adhesive layer, a thickness of the inorganic layer being D (μm), and the thickness D of the inorganic layer and the height H₂ of the corner portion protrusions having value ranges of: 0.5≤D≤6 and 20≤H₂≤80, respectively.

9. The electrode assembly according to claim 8, wherein the thickness D of the inorganic layer and the height H₂ of the corner portion protrusions have value ranges of: 1≤D≤3 and 20≤H₂≤60, respectively.

10. The electrode assembly according to claim 1, wherein the separator further comprises an inorganic layer, the inorganic layer being disposed between the base film and the adhesive layer, the inorganic layer comprising inorganic particles, an average particle size of the inorganic particles being E (μm), and the electrode assembly satisfying: 10≤H₂/E≤800.

11. The electrode assembly according to claim 10, wherein 20≤H₂/E≤180.

12. The electrode assembly according to claim 1, wherein the separator further comprises an inorganic layer, the inorganic layer being disposed between the base film and the adhesive layer, the inorganic layer comprising inorganic particles, an average particle size of the inorganic particles being E (μm), and the average particle size E of the inorganic particles and the height H₂ of the corner portion protrusions having value ranges of: 0.1≤E≤2 and 20≤H₂≤80, respectively.

13. The electrode assembly according to claim 12, wherein the average particle size E of the inorganic particles and the height H₂ of the corner portion protrusions have value ranges of: 0.3≤E≤1 and 20≤H₂≤60, respectively.

14. The electrode assembly according to claim 1, wherein the electrode assembly satisfies at least one of the following:
(1) the adhesive layer comprises adhesive particles, an average particle size of the adhesive particles being G (μm), wherein 10≤H₂/G≤800;
(2) a pore size of the adhesive layer is P (μm), wherein 0.2≤H₂/P≤160; or
(3) a pore size of the adhesive layer is P (μm), wherein 3≤1000R₂/P≤20000.

15. The electrode assembly according to claim 1, wherein the electrode assembly satisfies at least one of the following:
(1) the thickness of the adhesive layer is F (μm), wherein 10≤H₂/F≤120;
(2) the adhesive layer comprises adhesive particles, an average particle size of the adhesive particles being G (μm), wherein 20≤H₂/G≤600;
(3) a pore size of the adhesive layer is P (μm), wherein 0.4≤H₂/P≤120; or
(4) a pore size of the adhesive layer is P (μm), wherein 20≤1000R₂/P≤6000.

16. The electrode assembly according to claim 1, wherein the electrode assembly satisfies at least one of the following:
(1) the thickness of the adhesive layer is F (μm), the thickness F of the adhesive layer and the height H₂ of the corner portion protrusions having value ranges of: 0.1≤F≤5 and 20≤H₂≤80, respectively;
(2) the adhesive layer comprises adhesive particles, an average particle size of the adhesive particles being G (μm), and the average particle size G of the adhesive particles and the height H₂ of the corner portion protrusions having value ranges of: 0.1≤G≤2 and 20≤H₂≤80, respectively;
(3) a pore size of the adhesive layer is P (μm), the pore size P of the adhesive layer and the height H₂ of the corner portion protrusions having value ranges of: 0.5≤P≤100 and 20≤H₂≤80, respectively; or
(4) a pore size of the adhesive layer is P (μm), the pore size P of the adhesive layer and the average radial dimension R₂ of the second pattern having value ranges of: 0.5≤P≤100 and 0.3≤R₂≤10, respectively.

17. The electrode assembly according to claim 1, wherein the electrode assembly satisfies at least one of the following:
(1) the thickness of the adhesive layer is F (μm), the thickness F of the adhesive layer and the height H₂ of the corner portion protrusions having value ranges of: 0.5≤F≤2 and 20≤H₂≤60, respectively;
(2) the adhesive layer comprises adhesive particles, an average particle size of the adhesive particles being G (μm), and the average particle size G of the adhesive particles and the height H₂ of the corner portion protrusions having value ranges of: 0.1≤G≤1 and 20≤H₂≤60, respectively;
(3) a pore size of the adhesive layer is P (μm), the pore size P of the adhesive layer and the height H₂ of the corner portion protrusions having value ranges of: 0.5≤P≤50 and 20≤H₂≤60, respectively; or
(4) a pore size of the adhesive layer is P (μm), the pore size P of the adhesive layer and the average radial dimension R₂ of the second pattern having value ranges of: 0.5≤P≤50 and 1≤R₂≤3, respectively.

18. The electrode assembly according to claim 1, wherein the separator comprises a base film and an inorganic layer, the at least two electrode plates and the separator being wound around a winding core to form the electrode assembly, the main body portion protrusions being formed by the main body portion protruding toward the winding core, and the corner portion protrusions being formed by the corner portion protruding toward the winding core or formed by the corner portion protruding away from the winding core.

19. An electrochemical apparatus, comprising a housing and at least one electrode assembly, wherein the electrode assembly is disposed inside the housing; the electrode assembly comprises at least two electrode plates and a separator, the separator being disposed between two adjacent electrode plates;
wherein the electrode assembly is a wound electrode assembly, wherein each turn of the electrode plate in the wound electrode assembly includes two main body portions and two corner portions, and the two main body portions are connected between the two corner portions;
at least one of the electrode plates comprises a main body portion and corner portions located on both sides of the main body portion, the main body portion comprising multiple main body portion protrusions, a height of each main body portion protrusions is H₁ (μm), an orthographic projection of the each main body portion protrusions along a thickness direction of the electrode plate forming a first pattern, an average radial dimension of the first pattern of the main body protrusions is R₁ (mm), the corner portion comprising multiple corner portion protrusions, a height of each corner portion protrusions is H₂ (μm), an orthographic projection of the each corner portion protrusions along the thickness direction forming a second pattern, and an average radial dimension of the second pattern of the corner portion protrusions is R₂
$$( mm ) , wherein - 0.2 665 \leq {H}_{1} / 1000 {R}_{1} - {H}_{2} / 1000 {R}_{2} \leq 0.0131 ;$$
the separator comprises a base film and an adhesive layer, the adhesive layer being disposed on both sides of the base film, a thickness of the adhesive layer being F (μm), and the electrode assembly satisfying: 4≤H₂/F≤800.

20. An electronic apparatus, wherein the electronic apparatus comprises an electrochemical apparatus, the electrochemical apparatus comprises an electrode assembly; wherein the electrode assembly comprises at least two electrode plates and a separator, the separator being disposed between two adjacent electrode plates;
wherein the electrode assembly is a wound electrode assembly, wherein each turn of the electrode plate in the wound electrode assembly includes two main body portions and two corner portions, and the two main body portions are connected between the two corner portions;
at least one of the electrode plates comprises a main body portion and corner portions located on both sides of the main body portion, the main body portion comprising multiple main body portion protrusions, a height of each main body portion protrusions is H₁ (μm), an orthographic projection of the each main body portion protrusions along a thickness direction of the electrode plate forming a first pattern, an average radial dimension of the first pattern of the main body protrusions is R₁ (mm), the corner portion comprising multiple corner portion protrusions, a height of each corner portion protrusions is H₂ (μm), an orthographic projection of the each corner portion protrusions along the thickness direction forming a second pattern, and an average radial dimension of the second pattern of the corner portion protrusions is R₂
$$( mm ) , wherein - 0.2665 ⩽ H 1 / 1000 R 1 - H 2 / 1000 R 2 ⩽ 0.0131 ; and$$
the separator comprises a base film and an adhesive layer, the adhesive layer being disposed on both sides of the base film, a thickness of the adhesive layer being F (μm), and the electrode assembly satisfying: 4≤H₂/F≤800.
